(19) United States
(12) Patent Application Publication
(10) Pub. No.: US 2021/0010538 A1
(43) Pub. Date: Jan. 14, 2021

(54) SUSPENSION THRUST BEARING DEVICE AND SUSPENSION STRUT EQUIPPED WITH SUCH A DEVICE

(71) Applicant: AKTIEBOLAGET SKF, Goteborg (SE)

(72) Inventors: Charles Chambonneau, Ballan Mire (FR); Francois De Lemps, Saint-Cyr-sur-Loire (FR); Christophe Houdayer, Semblancay (FR); Desire Vidot, Ballan-Mire (FR)

(21) Appl. No.: 16/852,840

(22) Filed: Apr. 20, 2020

(30) Foreign Application Priority Data
Jul. 10, 2019 (CN) 201910617835.4

(51) Int. Cl. F16C 33/58; F16C 19/10; F16C 33/62

(52) U.S. Cl. CPC F16C 33/583; F16C 33/62; F16C 19/10

(57) ABSTRACT

A suspension thrust bearing device for use with a suspension spring in an automotive suspension strut of a vehicle includes a bearing having an upper annular bearing member and a lower annular bearing member configured for relative rotation. The lower annular bearing member includes a radial body and a damper having a radial portion made of resilient material overmolded to a lower side of the radial body. The damper radial portion has a lower support surface configured to axially support an end coil of the suspension spring, and the damper radial portion has a material hardness of 50 to 85 Shore A and an axial thickness of 2 to 10 mm.

### CROSS-REFERENCE

This application claims priority to Chinese patent application no. 201910617835.4 filed on Jul. 10, 2019, the contents of which are fully incorporated herein by reference.

### TECHNICAL FIELD

The present disclosure relates to a suspension thrust bearing device, in particular of the MacPherson type (“MacPherson Suspension Bearing Unit” or MSBU). The disclosure also relates to a strut for a motor vehicle, comprising a damper and such a suspension thrust bearing device. The field of the disclosure is that of suspension systems, notably motor-vehicle suspension systems.

### BACKGROUND

In a known manner, a motor vehicle suspension system comprises a suspension strut supporting an axle and a vehicle wheel. A suspension thrust bearing device is disposed in an upper portion of said suspension strut, opposite to the wheel and the ground, and between a suspension spring and an upper support block attached to the vehicle chassis.

The suspension thrust bearing device includes at least one bearing, for example a rolling bearing, comprising upper and lower annular bearing members configured for relative rotation around a main axis.

The suspension thrust bearing device enables transmission of axial forces between the spring and the body of the vehicle and, in the meantime, allows relative angular movement between the spring, which is mobile in rotation, and the fixed support block attached to the body.

The damping function of the suspension thrust bearing device can be improved using a damping element made of resilient material and mounted between the lower annular bearing member and the suspension spring. Such damping element absorbs shocks and vibrations exerted by the spring on the thrust bearing device. In a known manner, a good compromise has to be found between material, axial thickness of the damping element and compactness of the device to ensure optimized static and dynamic stiffness.

### SUMMARY

An aspect of the disclosure is to overcome these drawbacks by providing an enhanced suspension thrust bearing device. It is desirable to provide a suspension thrust bearing device which is relatively inexpensive, has a good operational reliability, and has an increased service life.

To this end, the disclosure relates to a suspension thrust bearing device for use with a suspension spring in an automotive suspension strut of a vehicle. The suspension thrust bearing device comprises a bearing having upper and lower annular bearing members configured for relative rotation. The lower annular bearing member comprises a radial body.

The suspension thrust bearing device further comprises a damping element having a damper radial portion made of resilient material and overmolded to lower side of the said radial body. Said damper radial portion has a lower support surface to axially support an end coil of the suspension spring.

According to the disclosure, the damper radial portion has a material hardness of 50 to 85 Shore A, and an axial thickness of 2 to 10 mm.

Thanks to the disclosure, the suspension spring transmits roadway shocks and vibrations to the suspension thrust bearing device through the damping element of relatively high axial thickness with respect to the radial body of the lower annular bearing member. The important damper thickness uniformly dampens the transmission of such shocks and vibrations.

According to further aspects of the disclosure which are advantageous but not compulsory, such a suspension thrust bearing device may incorporate one or several of the following features:

The suspension thrust bearing device comprises a bearing with a first ring fixed to an upper cap, so as to form the upper annular bearing member of the suspension thrust bearing, and a second ring fixed to a lower cap, so as to form the lower annular bearing member of the suspension thrust bearing, first and second rings being configured for relative rotation.

The bearing is a rolling bearing, the first and second rings defining an annular rolling chamber between them and at least one row of rolling elements being disposed within said rolling chamber.

The rolling elements are balls.

The first and second rings are made from a stamped metal sheet.

The upper and lower caps are made from a rigid plastic material.

The lower cap comprises an axial hub that extends axially downwardly from the inner side of said radial body.

The damping element comprises a damper axial portion that extends axially downwardly from the inner side of damper radial portion, said damper axial portion being fixed to outer surface of axial hub.

The damping element comprises rubber thermoplastic elastomer (TPE), in particular thermoplastic polyurethane (TPU) or styrenic thermoplastic (TPS), melt processible elastomer (MPE) or elastomer cellular foam.

The damper radial portion has a material hardness equal to one these value in the list: 50, 60, 75, or 85 Shore A.

The damper radial portion has an axial thickness of 5 to 10 mm, and advantageously equal to 8 mm.

The disclosure also relates to a motor vehicle suspension strut comprising a damper rod, a suspension spring, and a suspension thrust bearing device as mentioned above.

### BRIEF DESCRIPTION OF THE DRAWINGS

The disclosure will now be explained in correspondence with the annexed FIGURE, as an illustrative example, without restricting the object of the disclosure.

FIG. 1 is a sectional view of a suspension strut according to the disclosure, comprising a suspension thrust bearing unit also according to a first embodiment of the disclosure, and a damper rod and a suspension spring.

### DETAILED DESCRIPTION

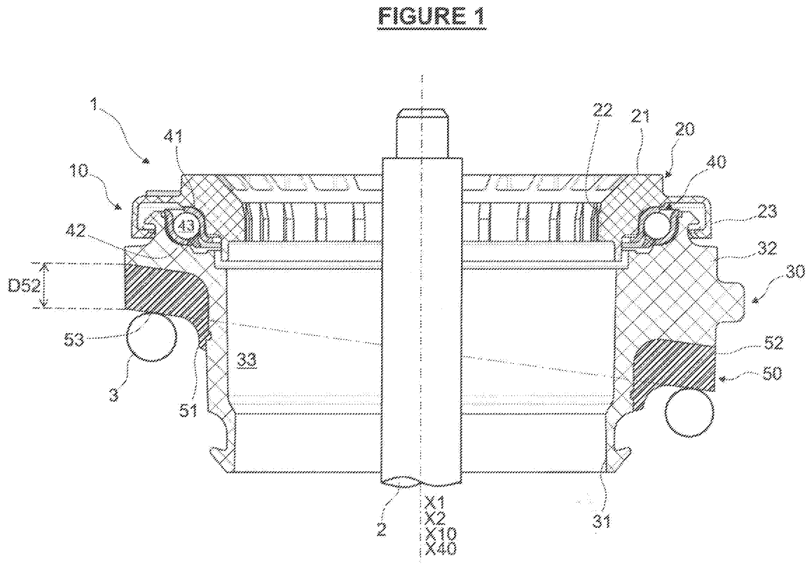

A suspension strut 1, partially shown in the annexed FIGURE, is incorporated into a motor-vehicle suspension system. The suspension strut 1 supports a vehicle axle and wheel which are not shown for the purposes of simplification. The suspension strut 1 extends along a main axis X1, placed in substantially vertical direction when the wheel of the vehicle rests on flat ground. The suspension strut 1 comprises a damper piston including a piston body and a damper rod 2 of axis X2, a coil suspension spring 3 and a suspension thrust bearing device 10. The rod 2 and the spring 3 are partially shown in FIG. 1, while the piston body is not shown for the purposes of simplification.

The suspension thrust bearing device 10 with main axis X10 is mounted between the spring 3 and a support block (not shown) connected to the chassis of a motor vehicle. The axis X2 and X10 coincide with the main axis X1 when the suspension system of the vehicle is at rest, as illustrated in FIG. 1.

Hereinafter, the adjectives “axial” and “radial” are defined relative to the main axis X10 of the annular thrust bearing device 10.

The suspension thrust bearing device 10 comprises an upper cap 20, a lower cap 30 and a single rolling bearing 40. In this embodiment, these three components 20, 30 and 40 are of globally circular shape about a main axis X40 coinciding with the main axis X10 when the suspension system of the vehicle is at rest.

The upper cap 20 is a one-piece part made from plastic synthetic material, for example from polyamide, optionally reinforced with glass fibers. The upper cap 20 has a radially-extending body 21 that defines an inner bore 22 for the suspension thrust bearing device 10 in which the damper rod 2 is mounted. The upper cap 20 also comprises an outer axially-extending skirt 23 of relatively large diameter and extending towards the lower side of the suspension thrust bearing device 10.

The upper cap 20 is configured to be fixed to a support block of the automotive vehicle chassis.

The rolling bearing 40 comprises a pressed sheet metal inner race 41, an outer race 42 also of pressed sheet metal, a row of rolling elements 43, here balls, and a cage (not referenced) for maintaining a regular circumferential spacing between the rolling elements 43. The rolling elements 43 are disposed in a rolling chamber defined between raceways formed by toroidal portions of the inner race 41 and outer race 42.

As an alternative not shown, no rolling elements need to be used but rather the inner and outer races may directly contact each other, with a suitable low friction material, coating, or lubricant being used.

The rolling bearing 40 is integrally radially located between the body 21 and the outer skirt 23 of the upper cap 20. The outer race 42 is fitted within a toroidal inner portion of the lower cap 30. The outer race 42 and the lower cap 30 form a lower annular bearing member. The inner race 41 is fitted onto a toroidal outer portion provided on the lower side of body 21 of the upper cap 20. The inner race 41 and the upper cap 20 form an upper annular bearing member. The upper and lower annular bearing members are in relative rotation with respect to the axis X40.

The lower cap 30 comprises an axially-extending hub 31 defining an inner bore 33 in which the rod 2 axially extends. The lower cap 30 further comprises a radial body 32 that radially outwardly extends from said hub 31. The toroidal outer portion supporting the inner race 41 of the rolling bearing 40 is provided on an upper surface of said radial body 32.

The upper cap 20 and the lower cap 30 are advantageously made of rigid plastic material, for example PA66 reinforced with glass fibers.

The lower cap 30 is further provided with a damping element 50 (or damper) made from a resilient material so as to enable vibrations to be filtered.

The damping element 50 comprises a tubular axial portion 51 and a radial portion 52. The radial portion 52 is tightly fastened to the lower side of the radial body 32 of the lower cap 30. The radial portion 52 comprises a lower support surface 53 for receiving an end turn of the suspension spring 3 in bearing contact. Said radial portion 52 of the damping element 50 supports axial load and shocks from the suspension spring 3.

The tubular axial portion 51 axially extends from the radial portion 52 towards the lower side of the suspension thrust bearing device 10. Said tubular axial portion 51 is tightly fastened to an outer cylindrical surface of the hub 31 of the lower cap 30. Said tubular axial portion 51 of the damping element 50 supports radial load and shocks from the suspension spring 2.

The tubular axial portion 51 and radial portion 52 of the damping element 50 are connected together so as to cover the exterior surface of the axial hub 31 and the radial body 32 of the lower cap 30.

The damping element 50 is made from a resilient material, such as rubber thermoplastic elastomer (TPE), in particular thermoplastic polyurethane (TPU) or styrenic thermoplastic (TPS), melt processible elastomer (MPE) or elastomer cellular foam. The damping element 50 is overmolded onto the lower cap 30.

According to the disclosure, the damping element 50 has a material hardness comprises between 60 and 85 Shore A. Advantageously, the hardness of damping element 50 is one of the listed values: 50 or 60 Shore A (very soft material), 75 (soft material), or 85 (hard material).

Furthermore, the axial thickness D52 of radial portion 52 of damper element has a thickness of 2 to 10 mm. Advantageously, the axial thickness is 5 to 10 mm, and is advantageously equal to 8 mm.

Representative, non-limiting examples of the present invention were described above in details with reference to the attached drawing. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provided improved suspension device.

Moreover, various features of the above-described representative examples, as well as the various independent and dependent claims below, may be combined in ways that are not specifically and explicitly enumerated in order to provide additional useful embodiments of the present teachings.

1. A suspension thrust bearing device, for use with a suspension spring in an automotive suspension strut of a vehicle, comprising:
a bearing having an upper annular bearing member and a lower annular bearing member configured for relative rotation, the lower annular bearing member comprising a radial body, and
a damper having a damper radial portion made of resilient material and overmolded to a lower side of the radial body, the damper radial portion having a lower support surface configured to axially support an end coil of the suspension spring,
wherein the damper radial portion has a material hardness of 50 to 85 Shore A, and an axial thickness of 2 to 10 mm.

2. The device according to claim 1, wherein the damper radial portion has a material hardness equal to 50 Shore A or 60 Shore A or 75 Shore A or 85 Shore A.

3. The device according to claim 1, wherein the damper radial portion has an axial thickness of 5 to 10 mm.

4. The device according to claim 1, wherein the damper radial portion has an axial thickness of 8 mm

5. The device according to claim 1, wherein the upper annular bearing member includes a first raceway and the lower annular bearing member comprises a second raceway.

6. Device according to claim 5,
wherein the bearing is a rolling bearing,
wherein the first and second raceways define an annular rolling chamber between them, and
wherein at least one row of rolling elements is disposed within the rolling chamber.

7. Device according to any of claim 5, wherein the lower cap comprises an axial hub that extends axially downwardly from an inner side of the radial body.

8. The device according to claim 7, wherein the damper comprises a damper axial portion that extends axially downwardly from the inner side of the damper radial portion, the damper axial portion being fixed to an outer surface of the axial hub.

9. The device according to claim 1, wherein the damper comprises rubber thermoplastic elastomer (TPE).

10. The device according to claim 1, wherein the damper comprises thermoplastic polyurethane (TPU) or styrenic thermoplastic (TPS) or melt processible elastomer (MPE) or elastomer cellular foam.

11. A motor vehicle suspension strut comprising a damper rod, a suspension spring, and a suspension thrust bearing device according to claim 1

12. A suspension thrust bearing device, for use with a suspension spring in an automotive suspension strut of a vehicle, comprising:
a bearing having an upper annular bearing member and a lower annular bearing member and a plurality of balls between the upper annular bearing member and the lower annular bearing member, the balls supporting the upper annular bearing member for rotation relative to the lower annular bearing member, the lower annular bearing member comprising a radial body and an axial hub extending axially from the radial body, and
a damper having a damper radial portion overmolded to a lower side of the radial body and a damper axial portion overmolded to the axial hub, the damper radial portion having a lower support surface configured to axially support an end coil of the suspension spring,
wherein the damper comprises a thermoplastic elastomer having a material hardness of 50 to 85 Shore A and an axial thickness of 5 to 10 mm.

13. The device according to claim 12, wherein the thermoplastic elastomer comprises thermoplastic polyurethane (TPU) or styrenic thermoplastic (TPS) or melt processible elastomer (MPE) or elastomer cellular foam.
